(19) United States
(12) Patent Application Publication
(10) Pub. No.: US 2025/0062933 A1
(43) Pub. Date: Feb. 20, 2025

(54) In-network compute operation spreading

(71) Applicant: Mellanox Technologies, Ltd., Yokneam (IL)

(72) Inventors: Yishai Oltchik, Givatayim (IL); Anton Korzh, Eagle, ID (US); Gil Bloch, Zichron Yaakov (IL); Itamar Rabenstein, Petach Tikva (IL)

(21) Appl. No.: 18/451,134

(22) Filed: Aug. 17, 2023

(51) Int. Cl. H04L 12/54

(52) U.S. Cl. CPC H04L 12/56

(57) ABSTRACT

In one embodiment, a network switch device includes a network interface to receive vectors from endpoint devices, and an aggregation and reduction accelerator to perform elementwise and vector splitting operations with the vectors as input yielding at least two intermediate vector results, wherein the network interface is to send the at least two intermediate vector results to different corresponding network switches in different switch aggregation trees, receive at least two final vector results of an aggregation and reduction process from the different switch aggregation trees, and combine the at least two final vector results to yield a combined final vector result, wherein the network interface is to send the combined final vector result to the endpoint devices.

### FIELD OF THE INVENTION

The present invention relates to computer systems, and in particular, but not exclusively to, in-network compute operations.

### BACKGROUND

A network node (e.g., including any suitable element(s) such as a graphics processing unit (GPU) and/or a central processing unit (CPU)) may initiate a parallel computing job with other GPUs across a network. In addition to the other GPUs participating in the parallel computing job, compute-resources in switches in the network may also participate in the parallel computing job by providing the various GPUs with the necessary data to perform the parallel computing job and also by performing such tasks as addition. The switches may perform reduction processing (e.g., summing two vectors together) and aggregation of data received from other network switches and/or GPUs.

For example, in-network resources may perform reduction operations with vectors including elementwise vector operations such as vector summation. The vectors may originate in endpoint devices and the object of the reduction operation may be to perform a vector operation (e.g., sum) on all the vectors. For example, if endpoint 1 has vector 1, endpoint 2 has vector 2, and so on, and endpoint N has vector N, then the object of the reduction operation may be to sum vectors 1 to N. At each switch, an in-network compute resource aggregates received vectors and provides the aggregated result to another switch in the direction of a root of a reduction tree. This is repeated at each switch in each layer of the tree until the root of the tree computes the sum of vectors 1 to N based on the vectors it receives from other switches below the root switch. The vector result is then propagated down the tree to the endpoint devices until the relevant (e.g., each) endpoint device receives the sum of vectors 1 to N.

An example of aggregation and reduction is provided in U.S. Pat. No. 10,284,383 to Bloch, et al., which describes a switch in a data network configured to mediate data exchanges among network elements.

### SUMMARY

There is provided in accordance with an embodiment of the present disclosure, a network switch device, including a network interface to receive vectors from endpoint devices as part of an aggregation and reduction process, and an aggregation and reduction accelerator to perform elementwise and vector splitting operations with the received vectors as input yielding at least two intermediate vector results, including a first intermediate vector result and a second intermediate vector result, wherein the network interface is configured to send the at least two intermediate vector results to different corresponding network switches in different switch aggregation trees including sending the first intermediate vector result to a first network switch in a first switch aggregation tree and the second intermediate vector result to a second network switch in a second switch aggregation tree, receive at least two final vector results of the aggregation and reduction process from the different switch aggregation trees including receiving a first final vector result from the first network switch and a second final vector result from the second network switch, and combine the at least two final vector results to yield a combined final vector result, wherein the network interface is configured to send the combined final vector result to the endpoint devices.

Further in accordance with an embodiment of the present disclosure the aggregation and reduction accelerator is configured to split the received vectors yielding at least two groups of split vectors, and perform elementwise operations on the split vectors the at least two groups yielding the at least two intermediate vector results for the at least two groups, respectively.

Still further in accordance with an embodiment of the present disclosure the aggregation and reduction accelerator is configured to perform elementwise operations on the received vectors yielding a given vector result, and split the given vector result yielding the at least two intermediate vector results.

Additionally in accordance with an embodiment of the present disclosure the aggregation and reduction accelerator is configured to perform elementwise operations with the received vectors as input, the elementwise operations being selected from any one or more of the following summation, point wise minimum, point wise maximum, bitwise OR, bitwise NOR, bitwise XOR, maximum value with index, minimum value with index, and a logical operation.

Moreover, in accordance with an embodiment of the present disclosure the aggregation and reduction accelerator is configured to perform elementwise summation with the received vectors as input, the received vectors having a floating-point value data type.

Further in accordance with an embodiment of the present disclosure the network interface is configured to receive the vectors from the endpoint devices in aggregation and reduction protocol packets, and the aggregation and reduction accelerator is configured to perform vector splitting packet boundaries.

Still further in accordance with an embodiment of the present disclosure the aggregation and reduction accelerator is configured to selectively perform elementwise operations with vector splitting for first received vectors and selectively perform elementwise operations without performing vector splitting for second received vectors.

Additionally in accordance with an embodiment of the present disclosure the aggregation and reduction accelerator is configured to determine to selectively perform elementwise operations with vector splitting for first received vectors based on the first received vectors having a floating-point value data type, and the elementwise operations including summation.

Moreover, in accordance with an embodiment of the present disclosure the aggregation and reduction accelerator is configured to determine to selectively perform elementwise operations without vector splitting for second received vectors based on either the second received vectors not having a floating-point value data type, or the elementwise operations not including summation.

Further in accordance with an embodiment of the present disclosure the aggregation and reduction accelerator, responsively to an administrator decision, is configured to selectively perform elementwise operations with vector splitting for first received vectors and selectively perform elementwise operations without performing vector splitting for second received vectors.

Still further in accordance with an embodiment of the present disclosure the aggregation and reduction accelerator, responsively to an aggregation manager decision based on a topology of the network, is configured to selectively perform elementwise operations with vector splitting for first received vectors and selectively perform elementwise operations without performing vector splitting for second received vectors.

There is also provided in accordance with another embodiment of the present disclosure, a networking method, including receiving vectors from endpoint devices as part of an aggregation and reduction process, performing elementwise and vector splitting operations with the received vectors as input yielding at least two intermediate vector results, including a first intermediate vector result and a second intermediate vector result, sending the at least two intermediate vector results to different corresponding network switches in different switch aggregation trees including sending the first intermediate vector result to a first network switch in a first switch aggregation tree and the second intermediate vector result to a second network switch in a second switch aggregation tree, receiving at least two final vector results of the aggregation and reduction process from the different switch aggregation trees including receiving a first final vector result from the first network switch and a second final vector result from the second network switch, combining the at least two final vector results to yield a combined final vector result, and sending the combined final vector result to the endpoint devices.

Additionally in accordance with an embodiment of the present disclosure, the method includes splitting the received vectors yielding at least two groups of split vectors, and performing elementwise operations on the split vectors the at least two groups yielding the at least two intermediate vector results for the at least two groups, respectively.

Moreover, in accordance with an embodiment of the present disclosure, the method includes performing elementwise operations on the received vectors yielding a given vector result, and splitting the given vector result yielding the at least two intermediate vector results.

Further in accordance with an embodiment of the present disclosure, the method includes performing elementwise operations with the received vectors as input, the elementwise operations being selected from any one or more of the following summation, point wise minimum, point wise maximum, bitwise OR, bitwise NOR, bitwise XOR, maximum value with index, minimum value with index, and a logical operation.

Still further in accordance with an embodiment of the present disclosure, the method includes performing elementwise summation with the received vectors as input, the received vectors having a floating-point value data type.

Additionally in accordance with an embodiment of the present disclosure the receiving vectors from endpoint devices includes receiving the vectors from the endpoint devices in aggregation and reduction protocol packets, and the performing includes performing vector splitting packet boundaries.

Moreover, in accordance with an embodiment of the present disclosure, the method includes selectively performing elementwise operations with vector splitting for first received vectors, and selectively performing elementwise operations without performing vector splitting for second received vectors.

Further in accordance with an embodiment of the present disclosure, the method includes determining to selectively perform elementwise operations with vector splitting for first received vectors based on the first received vectors having a floating-point value data type, and the elementwise operations including summation.

Still further in accordance with an embodiment of the present disclosure, the method includes determining to selectively perform elementwise operations without vector splitting for second received vectors based on either the second received vectors not having a floating-point value data type, or the elementwise operations not including summation.

Additionally in accordance with an embodiment of the present disclosure, the method includes, responsively to an administrator decision selectively performing elementwise operations with vector splitting for first received vectors, and selectively performing elementwise operations without performing vector splitting for second received vectors.

Moreover, in accordance with an embodiment of the present disclosure, the method includes, responsively to an aggregation manager decision based on a topology of the network selectively performing elementwise operations with vector splitting for first received vectors, and selectively performing elementwise operations without performing vector splitting for second received vectors.

There is also provided in accordance with still another embodiment of the present disclosure, a system, including a plurality of network switches including different switch aggregation trees of the network switches having a leaf layer of the network switches, wherein each of the network switches in the leaf layer is configured to receive vectors from respective endpoint devices as part of an aggregation and reduction process, perform elementwise and vector splitting operations with the received vectors as input yielding intermediate vector results, and send different ones of the intermediate vector results to the network switches in the different switch aggregation trees, the network switches in the different switch aggregation trees are to perform at least part of the aggregation and reduction process yielding different final vector results and provide the different final vector results to the network switches in the leaf layer, and each of the network switches in the leaf layer is configured to receive the different final vector results from the different switch aggregation trees, combine the different final vector results to yield a combined final vector result, and send the combined final vector result to the respective endpoint devices.

### BRIEF DESCRIPTION OF THE DRAWINGS

The present invention will be understood from the following detailed description, taken in conjunction with the drawings in which:

FIG. 1 is a block diagram view of multi-tree aggregation and reduction system constructed and operative in accordance with an embodiment of the present invention;

FIG. 2 is a block diagram view of one of the network switch devices in the system of FIG. 1;

FIG. 3 is a flowchart including steps in a method of operation of the system of FIG. 1;

FIG. 4 is a block diagram view illustrating one method of elementwise and splitting operations in the system of FIG. 1;

FIG. 5 is a block diagram view illustrating another method of elementwise and splitting operations in the system of FIG. 1;

FIG. 6 is a block diagram view illustrating combining vectors in the system of FIG. 1; and

FIG. 7 is a block diagram view of the system of FIG. 1 operating with a single aggregation and reduction tree.

### DESCRIPTION OF EXAMPLE EMBODIMENTS

### Overview

The performance of in-network compute operations may be degraded due to physical limitations of the network depending on its structure and the operation requirements. It may be possible to overcome these limitations by modifying the way applications running on endpoint devices utilize in-network compute resources, but such physical limitations may only apply to certain regions of the network. Furthermore, in many cases (e.g., cloud computing), the system operator does not wish to expose certain information to the user application (e.g., the network topology). However, it is extremely challenging for the user application to modify its usage of the in-network compute resources to avoid over-stressing a sensitive portion of the network topology when the user application is not informed of the relevant issue(s).

The following are examples of issues which may affect in-network compute operations and the aggregation and reduction process.

If the vectors to be processed are very large and a small number of network links are being used, then the network links are bombarded, creating a localized hotspot of contention within the network which may be undesirable.

In the SHArP aggregation and reduction protocol there is a requirement to reserve a receive buffer and send buffer in order to maintain reliability of transmission. The size of the buffer is proportional to latency of the link multiplied by the proportion of bandwidth. In some cases, if cables are too long (leading to higher latency) SHArP may be degraded, potentially even to the point where its functionality is limited or that it would confer no benefit.

Sometimes the data type (float data type, double data type, FP16, FP32, FP64) used by the end points is not the same as used by the switches. This is a particular issue with floating point operations. Data type refers to the number of bits used to represent a number. It is very common that end points use 16 bits to represent a single number, while switches use 32 bits to represent values belonging to intermediate computational steps even though the original values are in 16 bits. This may be done in order to limit the accumulation of numerical errors. Therefore, every one bit that the end points send over the network is transformed into two bits by the switches. If the endpoints are operating at full line rate, then the network needs to operate at double the line rate to keep up, and this is not always feasible.

Embodiments of the present invention address at least some of the above drawbacks by providing an aggregation and reduction system in which vector operations are divided among (two or more) different aggregation and reduction trees of switches.

In some embodiments networks switches in the leaf layer of the trees receive vectors from respective endpoint devices. For example, switch 1 receives vectors 1-3 from endpoints 1-3, switch 2 receives vectors 4-5 from endpoints 4-5, and so on. Each of the network switches in the leaf layer performs elementwise and vector splitting operations to yield intermediate vector results. In some cases, elementwise operations (e.g., summation) are performed prior to vector splitting. For example, switch 1 may perform elementwise vector operations on vectors 1-3 received from endpoints 1-3 to yield a vector result which is then split into two intermediate vector results. In other cases, vector splitting is performed prior to elementwise operations. In some embodiments, switch 1 may first split vectors 1-3 received from endpoints 1-3 to yield two groups of split vectors and then perform elementwise vector operations on each group of split vectors to yield two intermediate vector results.

An elementwise operation on two or more vectors performs the operations on the elements of the vectors independent of the other elements of the vectors. For example, the summation of vector A having elements a1, a2, and a3 with vector B having elements b1, b2, and b3 is given by a1+b1, a2+b2, and a3+b3.

Each network switch in the leaf layer then sends different intermediate vector results to the different aggregation and reduction trees for further processing. Switch 1 then sends one of the intermediate vector results to a switch in one of the aggregation and reduction trees and the other intermediate vector result to a switch in the other aggregation and reduction tree.

The vectors are processed by the switches in the different aggregation and reduction trees and passed up successive levels of the trees until all the vectors are reduced to a single final vector result in the root switch of each of the trees. The final vector results are then propagated down each of the trees until the final vector results are received by the switches in the leaf layer. The switches in the leaf layer then combine the received final vector results to yield a combined final vector result which is provided back to the respective endpoint devices. For example, final vector results 1 and 2 are propagated from the root switch of each respective tree (i.e., final vector result 1 is propagated from the root switch of tree 1, final vector result 2 is propagated from the root switch of tree 2) down to switch 1, which combines final vector results 1 and 2 to yield a combined final vector result, which switch 1 provides to endpoint device 1-3. The above examples refer to two aggregation and reduction trees. Embodiments of the present invention may include any suitable number of aggregation and reduction trees.

As the vector operations are performed elementwise, the vectors can be split in two or more sub-vectors (depending on the number of aggregation and reduction trees), processed by the switches in the different trees and then combined (e.g., concatenated) by the switches in the leaf layer to provide the same final vector result that would have been computed by switches in a single aggregation and reduction tree. In some embodiments, the splitting operations are based on the packet enumeration of the various vectors so that vectors are split according to packet boundaries so that all vectors are split identically at all regions of the network without requiring additional synchronization. In other embodiments, the vectors may be split according to any suitable method.

As the vectors are split (and recombined) in the switches and not in the endpoint devices, the splitting and recombination operation is transparent to the user applications running in the endpoint devices and therefore does not need the endpoint devices to have knowledge of the network topology.

In some embodiments, splitting the vectors and using more than one aggregation and reduction tree to process the split vectors may be selectively applied and may depend on various factors such as: a network administrator enforces splitting based on network congestion; a combination of data type and operation type (e.g., summation of any floating point value) may indicate splitting vectors, whereas other data types and operation types (e.g. computing minimum or maximum of floating point values, or summation of integers) may not indicate splitting vectors; based on a decision of an aggregation manager (e.g., an entity which, constructs switch trees and knows that the trees include long links and therefore to compensate for long links decides that the vectors should be split).

Using SHARP when the buffer requirements cannot be fully satisfied may result in a situation where SHArP is technically functional, but its performance is degraded. Under some circumstances, the performance degradation may be so great that the performance benefits of using SHARP are entirely negated or may result in worse performance. By splitting vectors, buffer requirements are reduced (e.g., halved) and may allow SHARP to be used without the abovementioned performance degradation. Vector splitting may lead to lower traffic on network links. Vector splitting may also eliminate the problem caused by doubling data representation size due to different data types, described above. Embodiments of the present invention improve the way a computer or other processing device works by providing better computer performance, providing higher processing speed, and providing less latency, among other improvements.

### SYSTEM DESCRIPTION

Reference is now made to FIG. 1, which is a block diagram view of multi-tree aggregation and reduction system 10 constructed and operative in accordance with an embodiment of the present invention. The system 10 includes endpoint devices 12 and network switches 14 (only some labeled for the sake of simplicity) arranged in a topology with network links 16 (only some labeled for the sake of simplicity) connecting the switches 14. FIG. 1 shows two aggregation and reduction trees 18 (18-1 and 18-2) of switches 14. The aggregation and reduction trees 18 are also referred to herein as switch aggregation trees. Each aggregation and reduction tree 18 includes a root 20 and a leaf layer 22. The leaf layer 22 includes switches 14 which may be included in both aggregation and reduction trees 18 (as shown in FIG. 1).

The switches 14 of aggregation and reduction tree 18-1 are shown with a stripped diagonal fill, while the switches 14 of the other aggregation and reduction tree 18-2 are shown with a checkered fill. The switches 14 in the leaf layer 22 are shown with a striped diagonal fill section and a checkered fill section as the switches 14 in the leaf layer 22 of FIG. 1 are included in both aggregation and reduction trees 18. The network links 16 between the switches 14 of aggregation and reduction tree 18-1 are shown with compound lines, and the network links 16 between the switches 14 of the aggregation and reduction tree 18-2 are shown with dashed lines.

The aggregation and reduction trees 18 of FIG. 1 include 3 layers. The aggregation and reduction trees 18 may include any suitable number of layers, any suitable number of switches 14, and may span any suitable number of endpoint devices 12. The aggregation and reduction trees 18 may span hundreds or thousands of endpoint devices 12, for example. FIG. 1 shows two aggregation and reduction trees 18. Three or more aggregation and reduction trees 18 may also be used to perform a single aggregation and reduction process. An even number of aggregation and reduction trees 18 may be more convenient than an odd number of aggregation and reduction trees 18.

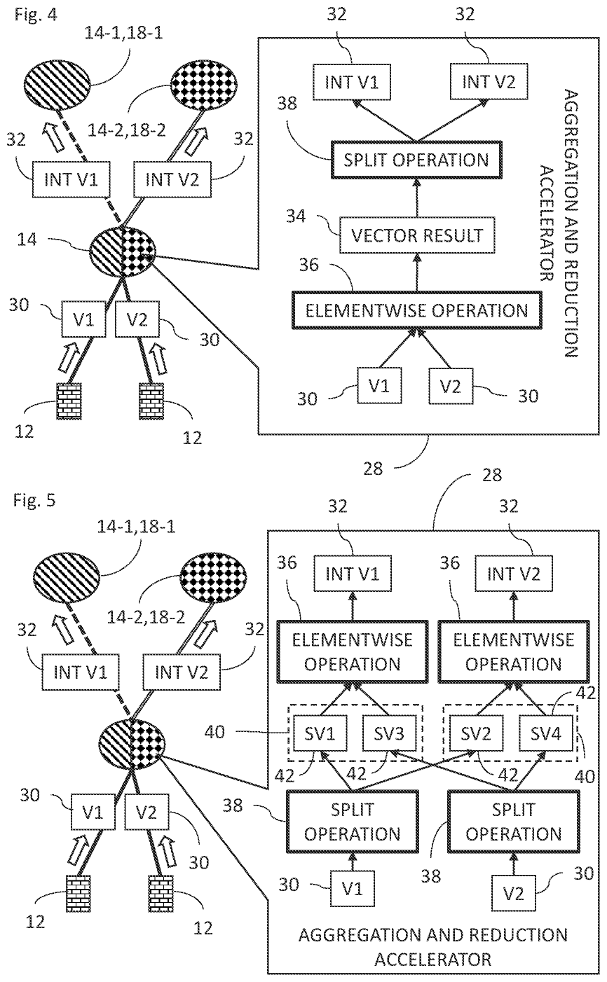

Each network switch 14 in the leaf layer 22 is configured to receive vectors from respective endpoint devices 12 as part of an aggregation and reduction process. Each network switch 14 in the leaf layer 22 is configured to perform elementwise and vector splitting operations with the received vectors as input yielding intermediate vector results. In some cases, elementwise operations (e.g., summation) are performed prior to vector splitting as described in more detail with reference to FIG. 4. In other cases, vector splitting is performed prior to elementwise operations as described in more detail with reference to FIG. 5.

Each network switch 14 in the leaf layer 22 is configured to send different intermediate vector results to the network switches 14 in the different switch aggregation trees 18. For example, one of the intermediate vector results is provided to aggregation and reduction tree 18-1 and another intermediate vector result is provided to aggregation and reduction tree 18-2.

The switches 14 in the different switch aggregation trees 18 are configured to perform at least part of the aggregation and reduction process yielding different final vector results and provide the different final vector results to the network switches 14 in the leaf layer 22. In particular, the intermediate vectors results are processed by the switches 14 in the different aggregation and reduction trees 18 and passed up successive levels of the trees 18 until all the vectors are reduced to a single final vector result in the root switch 20 of each of the trees 18. The final vector results are then propagated down each of the trees 18 until the final vector results are received by the switches 14 in the leaf layer 22.

Each network switch 14 in the leaf layer 22 is configured to receive the different final vector results from the different switch aggregation trees 18 and combine the different final vector results to yield a combined final vector result. Each network switch 14 in the leaf layer 22 is configured to send the combined final vector result to the respective endpoint devices 12.

As the vector operations are performed elementwise, the vectors can be split into two or more sub-vectors (depending on the number of aggregation and reduction trees), processed by the switches 14 in the different trees 18 and then combined (e.g., concatenated) by the switches 14 in the leaf layer 22 to provide the same final vector result that would have been computed by switches in a single aggregation and reduction tree.

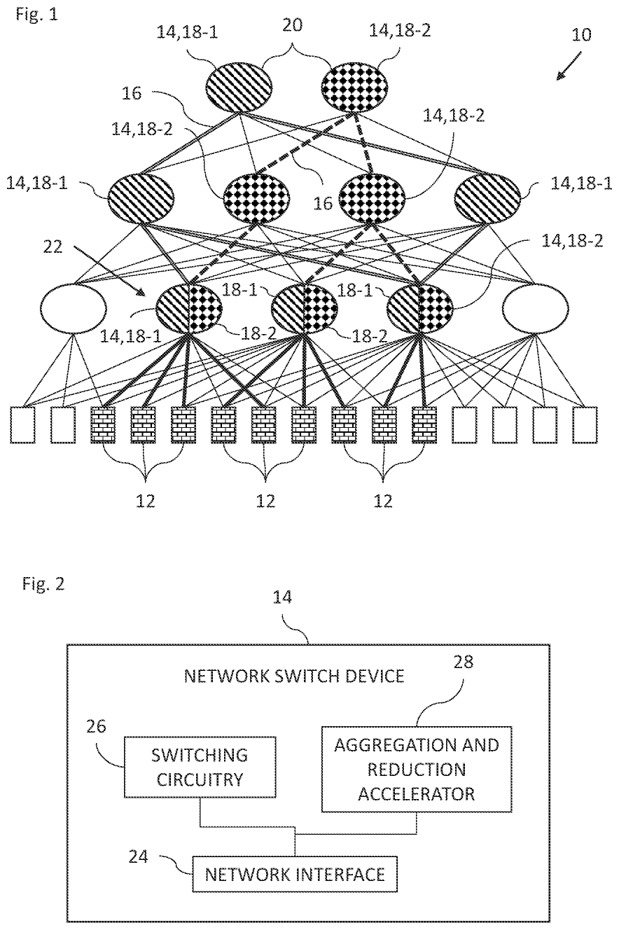

Reference is now made to FIG. 2, which is a block diagram view of one of the network switch devices 14 in the system 10 of FIG. 1. The switch 14 includes a network interface 24 including ports (not shown) configured to receive packets from, and send packets to, other switches 14 and optionally from the endpoint devices 12 (if connected directly to one or more of the endpoint devices 12). The packets may include aggregation and reduction protocol packets. A vector may be comprised in multiple aggregation and reduction protocol packets.

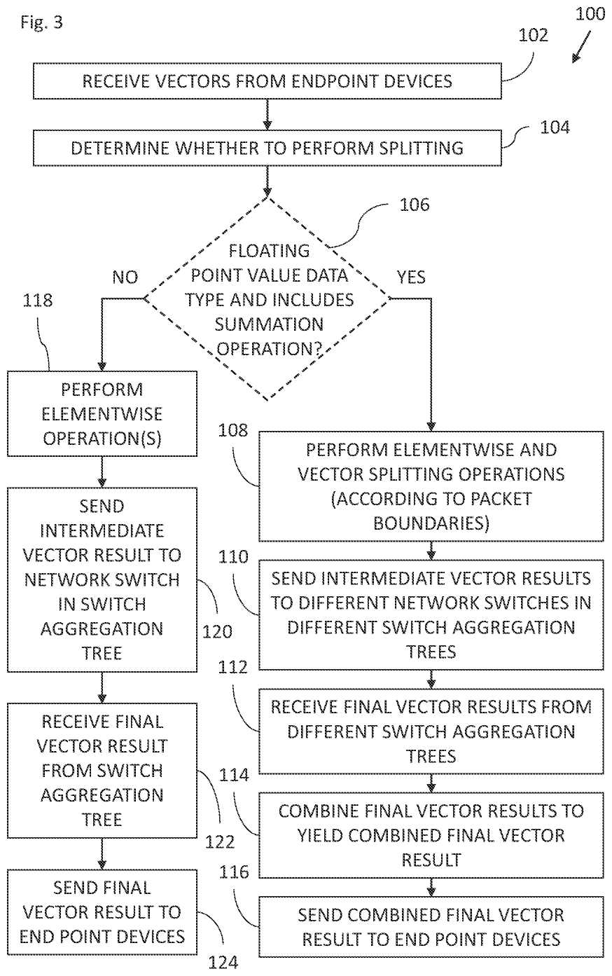

The switch 14 also includes switching circuitry 26 to provide appropriate connections between ports of received packets and ports of packets to be sent. The switch 14 also includes an aggregation and reduction accelerator 28 to perform elementwise and vector splitting operations with received vectors as input. The aggregation and reduction accelerator 28 is described in more detail with reference to FIGS. 3-6.

In practice, some, or all of the functions of the aggregation and reduction accelerator 28 may be combined in a single physical component or, alternatively, implemented using multiple physical components. These physical components may comprise hard-wired or programmable devices, or a combination of the two. In some embodiments, at least some of the functions of the aggregation and reduction accelerator 28 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Reference is now made to FIG. 3, which is a flowchart 100 including steps in a method of operation of the system 10 of FIG. 1. FIG. 3 describes processing inside one of the switches 14 in the leaf layer 22. The network interface 24 of the switch 14 is configured to receive vectors from endpoint devices 12 as part of an aggregation and reduction process (block 102). The endpoint devices 12 from which the network interface 24 receives vectors may be defined by the aggregation and reduction process and may include all, or a subset of, the endpoint devices 12 directly connected to the switch 14. In some embodiments, the network interface 24 is configured to receive vectors from the endpoint devices 12 in aggregation and reduction protocol packets. The network interface 24 is generally configured to receive one or more vectors from each of the endpoint devices 12 as part of an aggregation and reduction process. Each vector is generally carried in more than one packet so that when the vector is split in the switch 14 or a vector result is split in the switch 14, the split is according to packet boundaries, as described in more detail below with reference to FIG. 5.

In some embodiments, all received vectors are split by the switches 14 in the leaf layer 22 and the split vectors are processed by different aggregation and reduction trees 18. In some embodiments, splitting the vectors and using more than one aggregation and reduction tree 18 to process the split vectors may be selectively applied and may depend on various factors so that in some case vectors are not split and only one aggregation and reduction tree 18 is used to process the vectors.

The factors that may be considered to determine whether or not to selectively split received vectors and use more than one aggregation and reduction tree 18 include factors such as: a network administrator may enforce splitting based on network congestion; a combination of data type and operation type (e.g., summation of any floating point value) may indicate splitting vectors, whereas other data types and operation types (e.g. computing minimum or maximum of floating point values, or summation of integers) may not indicate splitting vectors; based on a decision of an aggregation manager (e.g., an entity which, constructs switch trees and knows that the trees include long links and therefore to compensate for long links decides that the vectors should be split). Therefore, in some embodiments, the aggregation and reduction accelerator 28 is configured to determine whether to perform splitting (block 104).

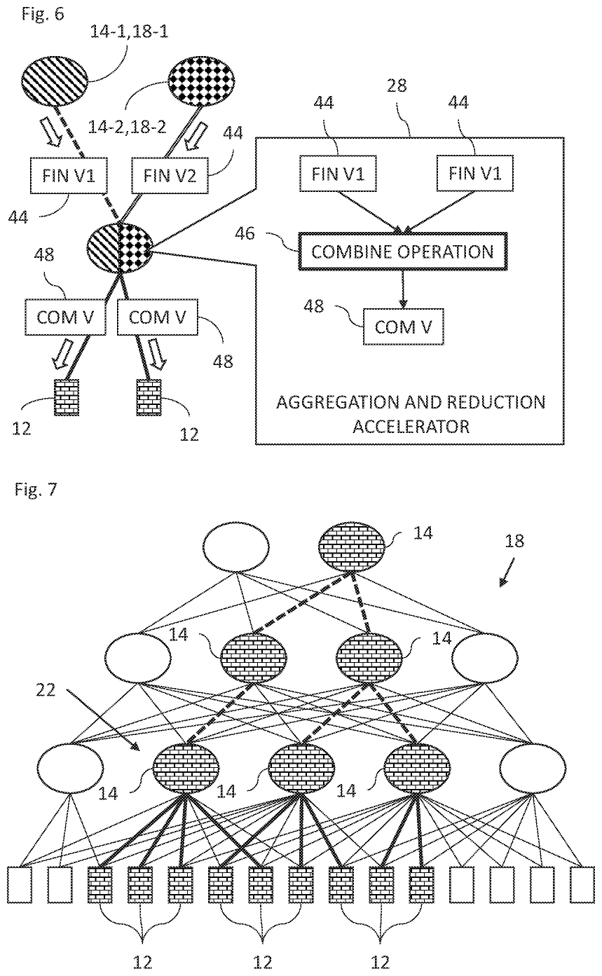

In some embodiments, the aggregation and reduction accelerator 28 is to selectively perform elementwise operations with vector splitting for some received vectors (described with reference to FIGS. 4-6 and the steps of blocks 108-116 of FIG. 3) and selectively perform elementwise operations without performing vector splitting for other received vectors (described with reference to FIG. 7 and the steps of blocks 118-124 of FIG. 3).

One of the factors mentioned above is data type and operation type. Therefore, in some embodiments, at a decision block 106, the aggregation and reduction accelerator 28 is configured to: determine to selectively perform elementwise operations with vector splitting for received vectors based on the received vectors having a floating-point value data type and the elementwise operations including summation; and determine to selectively perform elementwise operations without vector splitting for other received vectors based on either the other received vectors not having a floating-point value data type or the elementwise operations not including summation.

In some embodiments, the aggregation and reduction accelerator 28, responsively to an administrator decision, is configured to selectively perform elementwise operations with vector splitting for some received vectors, and selectively perform elementwise operations without performing vector splitting for other received vectors. In some embodiments, the aggregation and reduction accelerator 28, responsively to an aggregation manager decision based on a topology of the network, is configured to selectively perform elementwise operations with vector splitting for some received vectors, and selectively perform elementwise operations without performing vector splitting for other received vectors. In some embodiments, the aggregation manager decision may determine that all received vectors are subject to elementwise operations with vector splitting.

Reference is now made to FIG. 4, which is a block diagram view illustrating one method of elementwise and splitting operations in the system 10 of FIG. 1. Reference is also made to FIG. 3. In general, the aggregation and reduction accelerator 28 of the switch 14 in the leaf layer 22 is configured to perform elementwise and vector splitting operations with received vectors 30 (e.g., V1 and V2) as input yielding at least two intermediate vector results 32 including a first intermediate vector result (e.g., INT V1) and a second intermediate vector result (e.g., INT V2) (block 108).

In some cases, elementwise operations (e.g., summation) are performed prior to vector splitting, as described in more detail below with reference to FIG. 4. In other cases, vector splitting is performed prior to elementwise operations, as described in more detail below with reference to FIG. 5.

The aggregation and reduction accelerator 28 is configured to perform elementwise operations (block 36) on the received vectors 30 yielding a given vector result 34. In one example, the aggregation and reduction accelerator 28 is configured to perform elementwise summation with the received vectors as input, wherein the received vectors have a floating-point value data type. The elementwise operations may be selected from any one or more of the following: summation; point wise minimum; point wise maximum; bitwise OR, bitwise NOR, bitwise XOR, maximum value with index, minimum value with index, and a logical operation.

The aggregation and reduction accelerator 28 is configured to split (block 38) the given vector result 34 yielding the intermediate vector results 32 (e.g., INV V1 and INV V2). In some embodiments, the aggregation and reduction accelerator 28 is to perform vector splitting of the vector result 34 according to packet boundaries defined by the packets carrying the received vectors 30. In other embodiments, the splitting of the vector result 34 may be performed according to any suitable method.

The network interface 24 of switch 14 is configured to send the intermediate vector results 32 to different corresponding network switches 14 in different switch aggregation trees 18 (block 110) including sending the first intermediate vector result (e.g., INT V1) to network switch 14-1 in the aggregation and reduction tree 18-1 and the second intermediate vector result (e.g., INT V2) to network switch 14-2 in aggregation and reduction trees 18-2.

Reference is now made to FIG. 5, which is a block diagram view illustrating another method of elementwise and splitting operations in the system of FIG. 1. The aggregation and reduction accelerator 28 of the switch 14 in the leaf layer 22 is configured to split (blocks 38) the received vectors 30 yielding at least two groups 40 of split vectors 42 (e.g., SV1, SV2, SV3, SV4). In the example of FIG. 5, V1 is split into SV1 and SV2, and V2 is split into SV3 and SV4. One of the groups 40 of the split vectors 42 includes SV1 and SV3, while another one of the groups 40 of the split vectors 42 includes SV2 and SV4.

In some embodiments, the aggregation and reduction accelerator 28 of the switch 14 in the leaf layer 22 is configured to perform the vector splitting according to packet boundaries of received vectors 30 (e.g., V1 and V2). In streaming aggregations, each vector may be carried by multiple packets including a head and tail packet, and one or more body packets between the head and tail packets. All packet types may include vector data. However, head and tail packets may include other data (e.g., data identifying the aggregation and reduction process) that needs to be duplicated in packets sent to each of the aggregation and reduction trees 18. In other embodiments, the splitting of the received vectors 30 may be performed according to any suitable method.

The aggregation and reduction accelerator 28 is configured to perform elementwise operations (block 36) on the split vectors 42 according to the groups 40 yielding the intermediate vector results 32 for the groups 40, respectively. In the example of FIG. 5, the aggregation and reduction accelerator 28 is configured to perform elementwise operations (block 36) on SV1 and SV3 yielding INT V1, and elementwise operations on SV2 and SV4 yielding INT V2.

The network interface 24 of the switch 14 is configured to send the intermediate vector results 32 to different corresponding network switches 14 in different switch aggregation trees 18 (block 110) including sending the first intermediate vector result (e.g., INT V1) to network switch 14-1 in the aggregation and reduction tree 18-1 and the second intermediate vector result (e.g., INT V2) to network switch 14-2 in aggregation and reduction trees 18-2.

Reference is now made to FIG. 6, which is a block diagram view illustrating combining vectors in the system 10 of FIG. 1. The aggregation and reduction accelerator 28 of the switch 14 in the leaf layer 22 is configured to receive (via the network interface 24 of the switch 14) at least two final vector results 44 of the aggregation and reduction process from the different switch aggregation trees 18 including receiving a first final vector result (e.g., FIN V1) from the network switch 14-1 of the aggregation and reduction tree 18-1 and a second final vector result (e.g., FIN V2) from the second network switch 14-2 of the aggregation and reduction tree 18-2 (block 112).

The aggregation and reduction accelerator 28 is configured to combine (block 46) the final vector results 44 to yield a combined final vector result 48 (e.g., COM V) (block 114). The network interface 24 is configured to send the combined final vector result 48 to the endpoint devices 12 (block 116) from which the original vectors 30 were received.

Reference is now made to FIG. 7, which is a block diagram view of the system 10 of FIG. 1 operating with a single aggregation and reduction tree 18. Reference is also made to FIG. 3. As previously mentioned, in some embodiments, splitting the vectors and using more than one aggregation and reduction tree 18 to process the split vectors may be selectively applied and may depend on various factors so that in some case vectors are not split and only one aggregation and reduction tree 18 is used to process the vectors. When a decision is made not to split the vectors in the switches 14 (only some labeled for the sake of simplicity) of the leaf layer 22, the following steps are performed. The aggregation and reduction accelerator 28 of each switch 14 in the leaf layer 22 is configured to: perform elementwise operations on the received given vectors (received from respective endpoint devices 12) yielding an intermediate vector result (block 118); send the intermediate vector result to one of the switches 14 in the layer above the leaf layer 22 in the aggregation and reduction tree 18 (block 120); receive a final vector result from the switch 14 in the layer above the leaf layer 22 in the aggregation and reduction tree 18 (block 122); and send the final vector result to the endpoint devices 12 from which the given vectors were previously received by the switch 14 in the leaf layer 22 (block 124).

Various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

The embodiments described above are cited by way of example, and the present invention is not limited by what has been particularly shown and described hereinabove. Rather the scope of the invention includes both combinations and sub-combinations of the various features described hereinabove, as well as variations and modifications thereof which would occur to persons skilled in the art upon reading the foregoing description and which are not disclosed in the prior art.

What is claimed is:

1. A network switch device, comprising:
a network interface to receive vectors from endpoint devices as part of an aggregation and reduction process; and
an aggregation and reduction accelerator to:
perform elementwise and vector splitting operations with the received vectors as input yielding at least two intermediate vector results, including a first intermediate vector result and a second intermediate vector result, wherein the network interface is to send the at least two intermediate vector results to different corresponding network switches in different switch aggregation trees including sending the first intermediate vector result to a first network switch in a first switch aggregation tree and the second intermediate vector result to a second network switch in a second switch aggregation tree;
receive at least two final vector results of the aggregation and reduction process from the different switch aggregation trees including receiving a first final vector result from the first network switch and a second final vector result from the second network switch; and
combine the at least two final vector results to yield a combined final vector result, wherein the network interface is to send the combined final vector result to the endpoint devices.

2. The device according to claim 1, wherein the aggregation and reduction accelerator is to:
split the received vectors yielding at least two groups of split vectors; and
perform elementwise operations on the split vectors according to the at least two groups yielding the at least two intermediate vector results for the at least two groups, respectively.

3. The device according to claim 1, wherein the aggregation and reduction accelerator is to:
perform elementwise operations on the received vectors yielding a given vector result; and
split the given vector result yielding the at least two intermediate vector results.

4. The device according to claim 1, wherein the aggregation and reduction accelerator is to perform elementwise operations with the received vectors as input, the elementwise operations being selected from any one or more of the following: summation; point wise minimum; point wise maximum; bitwise OR, bitwise NOR, bitwise XOR, maximum value with index, minimum value with index, and a logical operation.

5. The device according to claim 1, wherein the aggregation and reduction accelerator is to perform elementwise summation with the received vectors as input, the received vectors having a floating-point value data type.

6. The device according to claim 1, wherein:
the network interface is to receive the vectors from the endpoint devices in aggregation and reduction protocol packets; and
the aggregation and reduction accelerator is to perform vector splitting according to packet boundaries.

7. The device according to claim 1, wherein the aggregation and reduction accelerator is to selectively perform elementwise operations with vector splitting for first received vectors and selectively perform elementwise operations without performing vector splitting for second received vectors.

8. The device according to claim 7, wherein the aggregation and reduction accelerator is to determine to selectively perform elementwise operations with vector splitting for first received vectors based on:
the first received vectors having a floating-point value data type; and
the elementwise operations including summation.

9. The device according to claim 8, wherein the aggregation and reduction accelerator is to determine to selectively perform elementwise operations without vector splitting for second received vectors based on either:
the second received vectors not having a floating-point value data type; or
the elementwise operations not including summation.

10. The device according to claim 1, wherein the aggregation and reduction accelerator, responsively to an administrator decision, is to selectively perform elementwise operations with vector splitting for first received vectors and selectively perform elementwise operations without performing vector splitting for second received vectors.

11. The device according to claim 1, wherein the aggregation and reduction accelerator, responsively to an aggregation manager decision based on a topology of the network, is to selectively perform elementwise operations with vector splitting for first received vectors and selectively perform elementwise operations without performing vector splitting for second received vectors.

12. A networking method, comprising:
receiving vectors from endpoint devices as part of an aggregation and reduction process;
performing elementwise and vector splitting operations with the received vectors as input yielding at least two intermediate vector results, including a first intermediate vector result and a second intermediate vector result;
sending the at least two intermediate vector results to different corresponding network switches in different switch aggregation trees including sending the first intermediate vector result to a first network switch in a first switch aggregation tree and the second intermediate vector result to a second network switch in a second switch aggregation tree;
receiving at least two final vector results of the aggregation and reduction process from the different switch aggregation trees including receiving a first final vector result from the first network switch and a second final vector result from the second network switch;
combining the at least two final vector results to yield a combined final vector result; and
sending the combined final vector result to the endpoint devices.

13. The method according to claim 12, further comprising:
splitting the received vectors yielding at least two groups of split vectors; and
performing elementwise operations on the split vectors according to the at least two groups yielding the at least two intermediate vector results for the at least two groups, respectively.

14. The method according to claim 12, further comprising:
performing elementwise operations on the received vectors yielding a given vector result; and
splitting the given vector result yielding the at least two intermediate vector results.

15. The method according to claim 12, further comprising performing elementwise operations with the received vectors as input, the elementwise operations being selected from any one or more of the following: summation; point wise minimum; point wise maximum; bitwise OR, bitwise NOR, bitwise XOR, maximum value with index, minimum value with index, and a logical operation.

16. The method according to claim 12, further comprising performing elementwise summation with the received vectors as input, the received vectors having a floating-point value data type.

17. The method according to claim 12, wherein:
the receiving vectors from endpoint devices includes receiving the vectors from the endpoint devices in aggregation and reduction protocol packets; and
the performing includes performing vector splitting according to packet boundaries.

18. The method according to claim 12, further comprising:
selectively performing elementwise operations with vector splitting for first received vectors; and
selectively performing elementwise operations without performing vector splitting for second received vectors.

19. The method according to claim 18, further comprising determining to selectively perform elementwise operations with vector splitting for first received vectors based on:
the first received vectors having a floating-point value data type; and
the elementwise operations including summation.

20. The method according to claim 19, further comprising determining to selectively perform elementwise operations without vector splitting for second received vectors based on either:
the second received vectors not having a floating-point value data type; or
the elementwise operations not including summation.

21. The method according to claim 12, further comprising, responsively to an administrator decision:
selectively performing elementwise operations with vector splitting for first received vectors; and
selectively performing elementwise operations without performing vector splitting for second received vectors.

22. The method according to claim 12, further comprising, responsively to an aggregation manager decision based on a topology of the network:
selectively performing elementwise operations with vector splitting for first received vectors; and
selectively performing elementwise operations without performing vector splitting for second received vectors.

23. A system, comprising a plurality of network switches including different switch aggregation trees of the network switches having a leaf layer of the network switches, wherein:
each of the network switches in the leaf layer is to:
receive vectors from respective endpoint devices as part of an aggregation and reduction process;
perform elementwise and vector splitting operations with the received vectors as input yielding intermediate vector results; and
send different ones of the intermediate vector results to the network switches in the different switch aggregation trees;
the network switches in the different switch aggregation trees are to perform at least part of the aggregation and reduction process yielding different final vector results and provide the different final vector results to the network switches in the leaf layer; and
each of the network switches in the leaf layer is to:
receive the different final vector results from the different switch aggregation trees;
combine the different final vector results to yield a combined final vector result; and
send the combined final vector result to the respective endpoint devices.
